(19) United States
(12) Patent Application Publication
(10) Pub. No.: US 2026/0211141 A1
(43) Pub. Date: Jul. 23, 2026

(54) TOMOGRAPHIC INVERSION

(71) Applicant: FNV IP B.V., Leidschendam (NL)

(72) Inventors: Moritz FLIEDNER, Leidschendam (NL); Myrna STARING, Leidschendam (NL); Rod EDDIES, Leidschendam (NL)

(73) Assignee: FNV IP B.V., Leidschendam (NL)

(21) Appl. No.: 19/137,427

(22) PCT Filed: Dec. 18, 2023
(86) PCT No.: PCT/EP2023/086450

§ 371 Date: Jun. 10, 2025

(30) Foreign Application Priority Data
Dec. 23, 2022 (NL) 2033826

(51) Int. Cl. G01V 1/30; G01V 1/28

(52) U.S. Cl. CPC G01V 1/305; G01V 1/282; G01V 2210/48

(57) ABSTRACT

There is provided a method for determining a physical property of a subsurface target volume, as well as systems and computer readable media for performing the same. The method comprises receiving a plurality of signals detected by a plurality of receivers arranged on a surface above the subsurface target volume, wherein each respective signal of the plurality of signals is detected by a respective receiver of the plurality of receivers, cross-correlating signals between the plurality of receivers to obtain empirical travel time data for surface waves between a plurality of virtual source-receiver pairs, determining a model of the physical property of the subsurface target volume, the model comprising a first plurality of cells arranged in a first two-dimensional grid, wherein each cell has a respective physical property value and wherein the two-dimensional grid spans at least the area of the surface. Unlocking insights from Geo-Data, the present invention further relates to improvements in sustainability and environmental developments: together we create a safe and livable world.

### TECHNICAL FIELD

The disclosure relates to methods and systems for analysing a target region beneath a surface of the earth. More particularly, the disclosure relates to a method and system for determining one or more material properties of the subsurface target region based on noise measured at or near the surface. In particular, the disclosure provides methods and systems for providing a model of a subsurface target region with improved accuracy. Unlocking insights from Geo-Data, the present invention further relates to improvements in sustainability and environmental developments: together we create a safe and livable world.

### BACKGROUND

There is a general and ongoing need for systems and methods for determining subsurface ground parameters. In particular, there is a need for systems and methods that can be used to model the properties of a target volume beneath the surface of the earth to provide the information useful for infrastructure planning. Determination of subsurface ground properties during the early planning phase of construction projects reduces uncertainty during the location determination, foundation design, and construction phases of a project. This in turn reduces delays, overspend, and unnecessary use of material resources (e.g., concrete) during construction.

One key parameter for the determination of ground characteristics in a volume of interest is shear-modulus and shear-velocity Vs. The shear velocity Vs is the velocity at which a shear wave moves through the material and is controlled by the shear modulus of the material. The relationship between shear-velocity and shear modulus G is defined by Vs=√G/ρ, where ρ is the density of the material. Measurement of Vs therefore provides a valuable insight to the material properties of a subsurface ground region.

Spectral analysis of surface waves (SASW) and multi-channel analysis of surface waves (MASW) are both examples of techniques for gathering surface wave information that can be used in the determination of material properties in a subsurface volume. In both of these techniques, surface-level vibrations are measured, either from a passive source (vibrations in the surface as a result of ambient sources of noise) or an active source (e.g., a weight drop), and the dispersion of the resulting surface waves is studied. ReMi (Refraction Microtremor) is another surface-level technique that uses ambient noise and surface waves to infer material properties of a subsurface region based on the observation of ambient noise at the surface.

Down-hole and cross-hole techniques can also be used to determine material properties of a subsurface region. In both of these methods, a receiver located in a bore hole measures waves received from an active source located elsewhere. In a down-hole technique, one of the source and the receiver is located at a subsurface location within the bore hole and the other of the source and the receiver is located at the surface. In a cross-hole technique, a source is located in a first bore hole, with a receiver located in a second bore hole. In both down-hole techniques, the propagation and dispersion of the received waves are studied to infer the properties of the material through which the waves from the receiver have travelled.

Invasive techniques for measuring material properties of a subsurface region can often present logistical challenges, especially in urban or inaccessible environments, and are often prohibitively expensive. Conversely, current surface-level techniques may lack the accuracy and reliability of more invasive analysis techniques.

### Overview

According to a first aspect of the present disclosure, a method for determining a physical property of a subsurface target volume is provided. The method comprises receiving a plurality of signals detected by a plurality of receivers arranged on a surface above the subsurface target volume, wherein each respective signal of the plurality of signals is detected by a respective receiver of the plurality of receivers, cross-correlating signals between the plurality of receivers to obtain empirical travel time data for surface waves between a plurality of virtual source-receiver pairs, and determining a model of the physical property of the subsurface target volume, the model comprising a first plurality of cells arranged in a first two-dimensional grid, wherein each cell has a respective physical property value and wherein the two-dimensional grid spans at least the area of the surface. While reference is made to virtual source-receiver pairs, the locations of these virtual source-receiver pairs may coincide with the physical placement of the receivers. That is, as ambient waves travel through the target volume, and are recorded by the plurality of receivers, a wave traveling between two receivers may be seen as travelling from a virtual source (i.e., the first receiver) to a receiver (i.e., the second receiver). As such, a virtual source-receiver pair may spatially coincide with the locations of the receivers placed on the surface of the target volume. As used herein, “empirical” data or information refers to such data or information obtained empirically, i.e by means of real signals collected at real receivers (such as geophones or accelerometers) positioned on the surface above the subsurface target volume. Determining the model comprises selecting a subset of the plurality of source-receiver pairs, wherein a surface wave path between each source and respective receiver traverses two or more cells of the first plurality of cells, and performing tomographic inversion on the empirical travel time data between each source-receiver pair in the subset to obtain the physical property value for each cell. By performing a tomographic inversion on the empirical travel time data for a plurality of source-receiver pairs in this way, a three-dimensional model of the physical property of the subsurface target volume can be obtained. This is by means of obtaining a one-dimensional model for each cell of the grid of cells, which collectively provide information on the physical property in three dimensions. This specific approach also takes into account the locational dependence between points, resulting in a smoother and more realistic model, i.e. being (relatively) free from physically impossible jumps in geophysical properties. This approach also allows for a higher resolution model to be produced without increasing the computational time to unfeasible levels.

In some examples, performing the tomographic inversion comprises obtaining an initial velocity model comprising initial values indicative of velocity for each of the cells of the first plurality of cells, for each source-receiver pair of the subset, determining a modelled travel time using the initial first velocity model values associated with the two or more cells that are traversed by the surface wave path; determining a first error value indicative of the difference between the modelled travel times and the corresponding empirical travel times for each source-receiver pair in the subset; and determining an updated velocity model based on the error value, wherein the updated velocity model comprises updated values indicative of velocity for each of the first plurality of cells. In some examples, determining the modelled travel time, determining the first error value, and determining the updated velocity model based on the error value are iterated until the error value meets a first end condition. The updated velocity model of each iteration is used as the initial velocity model of the next iteration. This provides an iterative process that allows for a highly accurate velocity model (velocity values in each cell of the model) to be obtained. In some examples, determining the modelled travel time, determining the first error value, and determining the updated velocity model based on the error value are performed using iterative non-linear least-squares inversion, which is a computationally efficient inversion technique. This is possible because the determination of the updated velocity is provided for each wave path and is less computationally intense compared to common alternatives (such as Monte Carlo methods).

In some examples, performing the tomographic inversion further comprises, for each cell of the first plurality of cells, performing an inversion of the value indicative of velocity to obtain the physical property value for the cell. The inversion may comprise obtaining an initial model of the physical property of the subsurface volume, wherein the initial model comprises initial physical property values for each of the cells of the first plurality of cells; for each cell of the first plurality of cells, determining modelled values indicative of velocity based on the initial physical property value for the cell; determining a second error value indicative of the difference between the modelled values indicative of velocity and the corresponding values indicative of velocity obtained from the updated velocity model; and determining an updated model of the physical property of the subsurface volume based on the second error value, wherein the updated model of the physical property of the subsurface volume comprises updated physical property values for each of the first plurality of cells. Determining the modelled values indicative of velocity, determining the second error value, and determining the updated model of the physical property of the subsurface volume based on the second error value are iterated until the second error value meets a second end condition, and wherein the updated model of the physical property of the subsurface volume of each iteration is used as the initial of the physical property of the subsurface volume of the next iteration. Determining the modelled values indicative of velocity, determining the second error value, and determining the updated model of the physical property of the subsurface volume based on the second error value may be performed using a computationally efficient least-squares inversion. This is possible because the determination of the dispersion functions is provided for each wave path and is less computationally intense compared to common alternatives (such as Monte Carlo methods).

In alternative examples, performing tomographic inversion comprises: obtaining an initial model of the physical property of the subsurface volume wherein the initial model comprises initial physical property values for each of the cells of the first plurality of cells; determining an empirical dispersion function for each source-receiver pair of the subset using the empirical travel time data; determining a modelled dispersion function for each source-receiver pair of the subset using the initial physical property values associated with the two or more cells that are traversed by a surface wave travelling from the source to the receiver; determining a third error value indicative of the difference between the modelled dispersion function and the empirical dispersion function for each source-receiver pair; and determining an updated model of the physical property of the subsurface volume based on the third error value, wherein the updated model of the physical property of the subsurface volume comprises updated physical property values for each of the first plurality of cells. By performing the features of determining a modelled dispersion function and comparing with the empirical dispersion function (by way of an error wave) for a section of source-receiver pairs, as opposed to individually per cell, the accuracy of determining the one or more physical property of the subsurface target volume is increased. This is because the update to the first model to produce the second model is performed in a single process for a given wave path, rather than using an initial tomographic process to find dispersion functions for individual cells using many wave paths which introduces additional approximation or inaccuracy.

Determining the modelled dispersion function for each source-receiver pair may comprise averaging, the physical property values of the two or more cells that are traversed by a surface wave travelling from the source to the receiver, and calculating the modelled dispersion function using the averaged physical property value. Alternatively, determining the modelled dispersion function for each source-receiver pair may comprise calculating a cell dispersion function for each of the two or more cells that are traversed by a surface wave travelling from the source to the receiver to provide a plurality of cell dispersion functions, wherein calculating each cell dispersion function comprises using the physical property value of the respective cell, and averaging the plurality of cell dispersion functions. In some examples, the path taken by a surface wave between each source and receiver pair is represented by a straight or curved ray. In these examples, the averaging may comprise determining a weighted average according to a respective weight for each cell of the two or more cells, wherein the respective weight for each cell corresponds to a segment length of the ray path in that cell. In other examples, the path taken by a surface wave between each source and receiver pair is represented by a Fresnel zone. In these examples, the averaging comprises determining a weighted average according to a respective weight for each cell of the two or more cells, wherein the respective weight for each cell corresponds to a sensitivity value of the Fresnel zone in that cell.

By averaging over cells in each wave path, the model is more accurate as it more closely reflects how the wave path between a pair of receivers behaves. This process also provides a feasible way to achieve a high-resolution model, i.e. having smaller cell sizes and therefore more precise resulting model. The weighted average approach also increases the accuracy by accounting for the different affect different cells have on each wave path.

In some examples, determining the updated model of the physical property of the subsurface comprises updating the initial physical property value of each cell according to a respective weighting of the path taken by a surface wave in that cell. For example, the change in physical property value of each cell may be weighted as described above. These techniques mean that the resulting model corresponds more closely to the actual physical properties of the subsurface target volume and may also decrease the time or iterations needed to find the final model to fit the detected signals.

In some examples, determining the second model comprises determining partial derivatives of the third error value with respect to the one or more physical properties of the first model; determining a sensitivity matrix comprising the partial derivatives; solving a linear system of equations defined by the sensitivity matrix to determine desired changes to the one or more initial physical property values of the initial model; and updating the initial model according to the desired changes to produce the updated model of the physical property of the subsurface volume. This provides a precise way to implement the changes to the initial model to produce the updated model, and therefore produces an updated model which more closely maps onto the actual physical properties of the subsurface target volume.

In some examples, determining the modelled dispersion function based on the initial model, determining the third error value, and determining the updated model of the physical property of the subsurface volume are iterated until the third error value meets a third end condition, wherein the updated model of each iteration is used as the initial model of in the next iteration. The end condition may include one or more of: the third error value of a latest iteration is less than a predetermined threshold error value; and a difference between the third error value of a latest iteration and the third error value of a preceding iteration is less than a predetermined difference threshold. This further increases the accuracy of the final updated model, as each iteration aligns the model more closely to the detected signals (and, in particular, the dispersion functions determined therefrom). The end conditions control the balance between optimising the second model to the actual physical properties in the subsurface target volume and reducing computational time.

In some examples, the determining the modelled dispersion function, the determining the third error value, and the determining the updated physical model are performed using non-linear iterative least squares inversion. This is possible because the determination of the dispersion functions is provided for each wave path and is less computationally intense compared to common alternatives (such as Monte Carlo methods).

In some examples, the initial model of the physical property of the subsurface volume provides initial physical property values in at least two spatial dimensions, and optionally in three spatial dimensions. This provides a more accurate and geologically realistic initial model which in turn enables a more accurate and geologically realistic final physical property model to be obtained. A more accurate initial model in two or more spatial dimensions can also lead to a reduced number of iterations before the end condition is reached, thereby making the whole process for obtaining the model of the subsurface target volume more efficient. In some examples, the initial model of the physical property of the subsurface volume is derived from empirical phase dispersion data obtained from signals detected between a second subset of the plurality of source-receiver pairs. This is useful because a rudimentary initial model can be obtained based on empirical phase velocity information obtained for a plurality of source-receiver pairs. This means that the initial model is empirically based on the subsurface target volume itself, resulting in a more accurate initial model for any given subsurface target volume.

In some examples. the initial physical property value and updated physical property for each cell is a shear wave velocity as a function of depth. This is a useful physical property to model because it has a particularly significant influence on surface wave propagation. In some implementations, the method may comprise calculating, for one or more cells of the second model, a compressional wave velocity value and/or a density value using the shear wave velocity value. That is, any combination of shear wave velocity, a compressional wave velocity value and a density value may be included in the model.

In some examples, the empirical dispersion function and the modelled dispersion function comprise group velocity dispersion functions and/or phase velocity dispersion functions. This is useful because either group or phase dispersion data can be used to obtain the model of the subsurface target volume. Either group or phase data can be used, depending on the availability of either type of data, the quality of either type of data, or other factors that may mean either one of group or phase data is more desirable than the other. Alternatively, both phase and group data can be used in the tomographic inversion processes described herein, to produce a more accurate model of the physical properties of the subsurface target volume.

In some examples, the method comprises, outputting the updated model of the subsurface target volume to an output device.

According to another aspect of the present disclosure, there is provided a system comprising one or more processors and one or more memories having stored thereon computer-readable instructions configured to cause the one or more processors to perform any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF THE DRAWINGS

Disclosed implementations will now be described by way of example to illustrate aspects of the disclosure and with reference to the accompanying drawings, in which:

FIG. 1 shows a cross-sectional view of a subsurface target volume;

FIG. 2 shows a plurality of geophones arranged on a surface above a subsurface target volume;

FIG. 3 is a perspective view of a shear wave velocity model;

FIG. 4A is an overhead view of a ray path on a surface above a subsurface target volume, with a shear wave velocity model superimposed thereon;

FIG. 4B is an overhead view of a ray path on a surface above a subsurface target volume, with a shear wave velocity model superimposed thereon;

FIG. 4C is an overhead view of an elliptical Fresnel kernel representing a surface wave path above a subsurface target volume, with a shear wave velocity model superimposed thereon

FIG. 4D is an overhead view of a curved Fresnel kernel representing a surface wave path above a subsurface target volume, with a shear wave velocity model superimposed thereon;

FIG. 5 is a schematic diagram of a method for determining one or more physical properties of a subsurface target volume;

FIG. 6 is a schematic diagram of a method for determining a surface wave group velocity model;

FIG. 7 is a schematic diagram of a method for determining one or more physical properties of a subsurface target volume;

FIG. 8 is a schematic diagram of a method for determining one or more physical properties of a subsurface target volume

FIG. 9 is an example of a shear wave velocity model resulting from the methods described herein; and

FIG. 10 is a schematic diagram of a computing device suitable for performing the methods described herein.

### DETAILED DESCRIPTION OF THE DRAWINGS

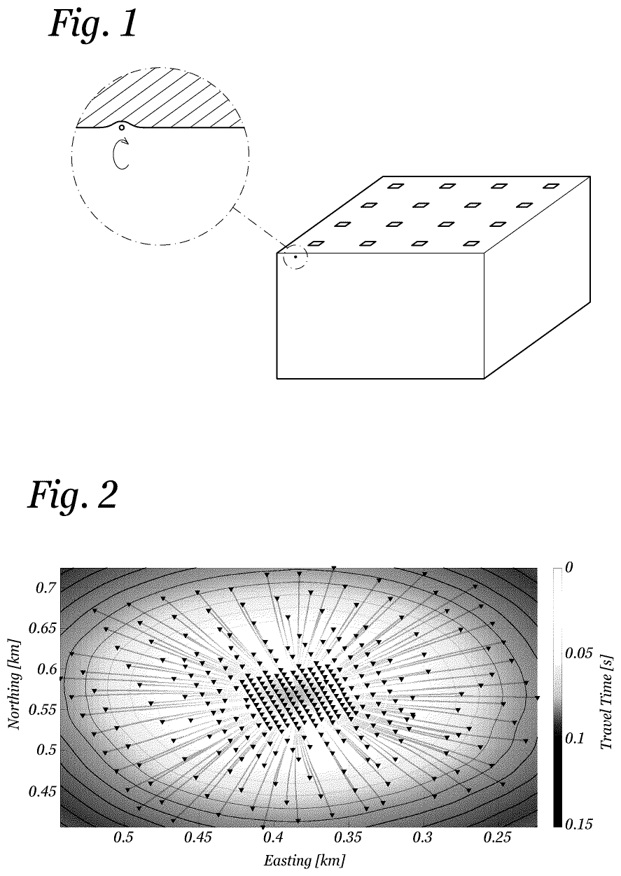

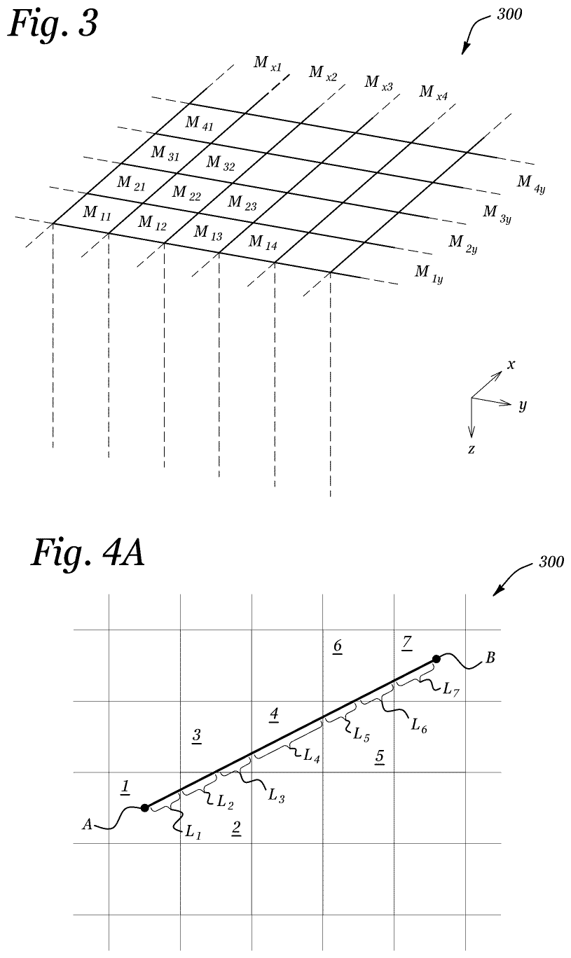

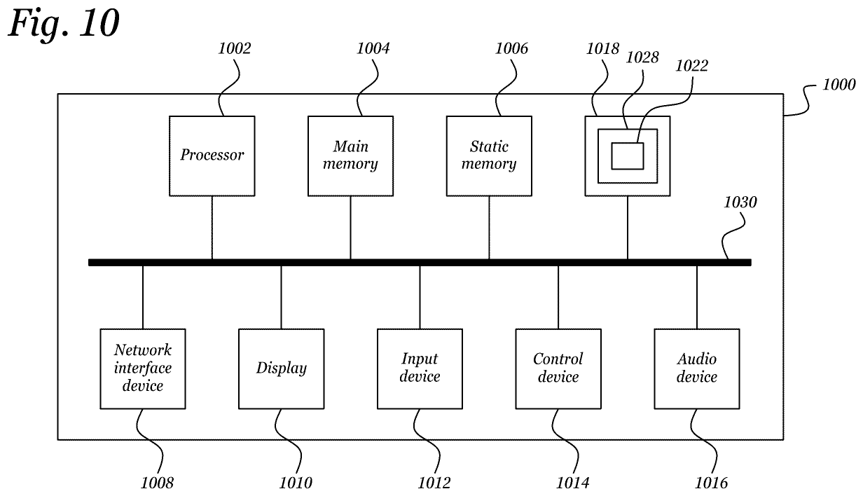

This detailed description describes, with reference to FIGS. 1 and 2, an approach to measuring structural properties of a ground volume using receivers, which in the context of this illustrative embodiment, are geophones. Next, with reference to FIGS. 3-9, novel methods for performing tomographic inversion using signals detected by geophones are disclosed. Finally, a computing device that may be used to perform the disclosed methods is described with reference to FIG. 10.

The following examples will be described in the context of a geophone array, to aid understanding. It will, however, be appreciated that the disclosed systems and methods are applicable to a variety of receiver types, including but not limited to geophones, accelerometers, velocimeters, seismometers, vibration sensors and/or transducers. The disclosed methods may be applied to any suitable set of signals.

The methods and systems disclosed herein relate generally to processing signals detected by geophones on a surface. In one particular example, the geophones are placed on a ground surface and the detected signals are ambient noise signals. Processing of these signals provides useful insight into the structure of the surface and subsurface target volume on which the geophones are placed, as described in more detail below. Due to the potentially very large number of signals being processed, an increased accuracy and/or resolution of information about the subsurface target volume can be achieved. However, using a large number of signals also means that computationally efficient methods are useful to ensure that processing of the signals is feasible within a practical length of time. The methods and systems disclosed herein provide an approach for performing processes to produce accurate, high-resolution information about the subsurface target volume in a computationally efficient and practically feasible manner.

Before turning to the details of the disclosed methodology, some background relating to determination of surface and subsurface properties using geophones will first be provided. Shear modulus is a measure of the elastic shear stiffness of a material and represents the deformation of a solid when it experiences a force parallel to one of its surfaces while its opposite face experiences an opposing force. Such forces and their effects in subsurface target volumes are an important parameter for study before and during the design of building and infrastructure projects. To determine the shear modulus of a volume, the shear velocity, Vs, is determined. This in turn gives an indication of the stiffness of the subsurface material, and its ability to support structures positioned above and/or through the volume.

In the context of ground study, two types of waves are generally distinguished: P-waves, in which particles in the volume oscillate in the direction of movement of the wave, cause a compression and de-compression of the ground as the waves propagate through the ground. S-waves are shear waves, in which particles oscillate in a direction perpendicular to the direction of propagation of the waves.

P-waves and S-waves are body waves and propagate in all directions through the body of the volume. The interaction of P- and S-waves with the earth's surface generates surface waves, which propagate along that surface. Several types of surface waves can be distinguished. In the systems and methods described herein, Rayleigh waves are measured and studied because it is convenient to measure the vertical component of surface vibrations. However, it will be appreciated that other surface waves (e.g. Love waves) may be measured and harnessed in the systems and methods described herein.

Because surface waves propagate in 2D (at the surface), they attenuate less rapidly than body waves (which propagate in 3D). Surface waves are generally present within a depth range of one wavelength from the surface, generally travel more slowly and have a predominantly lower frequency than body waves.

This lower attenuation, slower travel time and lower frequency of surface waves makes their study particularly attractive for the purposes of determining shear velocity, Vs. Since the surface waves have lower attenuation, the signal strength is better maintained through over a longer travel distance. The resulting measurement results therefore generally have a higher signal quality (signal-to-noise ratio) than body wave studies.

Referring now to FIG. 1, a cross-sectional view of a subsurface volume 100 is shown. P- and S-waves travel through the volume 100 as body waves. A surface 102 extends above the subsurface volume. Surface waves propagate along the surface 102.

At an example point, a schematic representation of a particle oscillation (due to Rayleigh wave propagation) at a surface above a target subsurface volume is shown. As illustrated, the oscillation of the particle P is partly vertical and partly parallel to the direction of propagation. The resulting particle movement is therefore substantially ellipsoidal.

At a surface 102 above the volume 100, a plurality of geophones 104 are arranged. Geophones 104, located at surface 102 can be configured to measure the vertical component of the oscillation shown schematically at the example point.

The geophones 104 are arranged in a grid array at the surface, the grid extending in two directions. It should be noted that the surface above the target region may, in many cases, not be planar. The array of geophones 104 may therefore not be truly “2-dimensional” because each geophone may be offset from its neighbours in the grid in the z-direction. However, such a grid arrangement of geophones will be referred to as a 2D array herein for simplicity.

It will also be appreciated that in the context of sub-surface ground study, the term 2D array may also be used to denote an array configured to capture 2D information (e.g. a line of receivers configured to provide information regarding a 2D slice of a target region) and a 3D array may refer to a grid of receivers configured to capture 3D information. However, in the context of the present information, the term 2D in the context of receivers is intended to refer to the 2-dimensional configuration of the receivers rather than the information gathered.

A surface wave travelling across surface 102 will cause vertical movement at a plurality of geophones 104 as waves travel across the surface.

To determine the shear velocity, Vs, from the observation of surface waves (in particular Rayleigh waves), the dispersive behaviour of the surface waves can be measured. Surface waves are dispersive, which means that their velocity is dependent on frequency. Usually, seismic velocities increase with depth in the earth. As a consequence, normal surface wave dispersion shows a decrease of surface-wave velocity with increasing frequency. It is by studying the behaviour of surface waves at a surface above the subsurface target volume that the material properties of the volume can be determined.

There are two ways to measure the velocity in dispersive surface waves and a distinction is made between the determination of group velocity or phase velocity.

The group velocity of a wave is the velocity with which the overall envelope shape of the wave's amplitudes—known as the modulation or envelope of the wave—propagates through space. The group velocity is equivalent to the speed at which the energy of the wave propagates through the volume. The group velocity is measured by determining the wave propagation between a (synthetic) transducer pair and is a frequency-dependent point property in the volume, which is dependent on depth. The group velocity is obtained as a time-of-flight measurement between a (virtual) source and a receiver.

The phase velocity is the speed at which a particular frequency component of a wave travels. As such, the phase velocity is expressed as a function of frequency. To measure the phase velocity, at least two measurement nodes are chosen to measure the waves propagating through the volume to determine relative time of flight between the geophones for different frequencies. The result is the phase velocity as a function of frequency as averaged over the volume between the two measurement nodes. Phase velocity is acquired as a point in 2D phase space (dispersion spectrum) which is obtained by a 2D transform (such as slant-stack, Radon, FK, or the like) of an array of recorded waveforms (time-distance space).

Referring to again to FIG. 1, each geophone 104 provides a measurement node for measuring the vertical component of passing surface waves. The geophones 104 can be configured to measure vibrations due to ambient noise. That is, the background wavefield due to natural or man-made noise (rather than an impulse point such as an explosion or hammer drop used in active methods).

By cross-correlating the passive noise signals measured at a pair of receivers, the Green's function for the pair can be obtained, which represents the wavefield as if one of the pair were a virtual source and the other of the pair were a receiver.

FIG. 2 shows a plurality of virtual source-receiver pairs across a surface above a subsurface target volume. Ray paths 202 between source-receiver pairs are indicated, in particular, the ray paths from a single central geophone near the centre of the array of geophones and each other geophone in the array. The background shading and contour rings indicate the travel-time field from the central geophone to the other geophones. There are also corresponding ray paths between each geophone and all other geophones, i.e. between every pair of geophone, which are not depicted in FIG. 2 for simplicity.

Each pair of geophones can provide a signal at a first location to be cross-correlated with a signal at a second location to reproduce a virtual source-receiver pair using the principle of interferometry. In particular, the cross-correlation of passive noise measured at respective pairs of geophones at the surface shown in FIG. 1 can be used to reproduce a response from the subsurface target volume, as if it were induced by an impulse point source, which is equal to Green's function.

In other words, a response that is received by cross-correlating two receiver recordings can be interpreted as a response that would have been measured at one of the receiver locations as if there were a source at the other. Various approaches to determining the Green's function for a virtual source-receiver pair are known, with an overview of the approaches described in “Tutorial on Seismic Interferometry: Part 1—Basic Principles and Applications”; GEOPHYSICS. Vol. 75, No 5 (September-October 2010; P.75A195075A209; Wapenaar et al.).

With reference to FIG. 3, a first shear wave velocity model 300 has a grid of cells m_{xy} across the surface above the subsurface target volume, comprising columns mₓ₁, mₓ₂, mₓ₃, etc. extending in the x-direction and rows m_{1y}, m_{2y}, m_{3y}, etc extending in the y-direction. Each cell defines an area of the surface. For example, each cell may define a 5 m by 5 m square; other example options include a 1 m by 1 m square, or a 10 m by 10 m square. In other words, the shear wave velocity model comprises a plurality of cells arranged in a two-dimensional grid 300. The two-dimensional grid spans at least the area of the surface above the subsurface target volume. Choosing a smaller cell area increases the resolution of the model. Each cell also includes a volume extending vertically below the area of the surface. The model 300 may extend infinitely below the area of the surface or to a predetermined depth below the surface for which the shear wave velocity value has a notable influence on the propagation of surface waves propagating on the surface. For example, the model 300 may be defined up to a depth of 50 m, 100 m, 200 m or 300 m.

In some examples, the first shear wave velocity model 300 is not a grid of square cells but instead comprises cells having a rectangular shape, a rhombic shape or otherwise tessellating shapes including non-uniform shapes or a combination of different shapes.

Each cell is associated with a shear wave velocity value, an example of a physical property value, which represents the expected value of shear wave velocity in the actual subsurface target volume of interest. The shear wave value carries depth information, either in that the shear wave value is constant throughout the volume below the cell area or in how the shear wave value varies with depth (the z direction in FIG. 3). For example, the defined shear wave value for each cell may be explicitly a function of depth, either a continuous function or a series of values with associated ranges of depth for each value. In another example, the shear wave velocity value may be a function of frequency, which corresponds to depth information because surface wave propagation is influenced by the physical properties of the subsurface volume up to approximately one wavelength depth. In other words, surface waves at low frequencies are affected by physical properties at deeper depths than surface waves at high frequencies.

In other examples, the model may a physical property other than shear wave velocity, such as compressional wave velocity, density, elastic modulus, shear modulus, or, if a viscoelastic model is being used, optionally also viscosity quality factors Qₛ and Qₚ. In general, the model may define multiple physical property values.

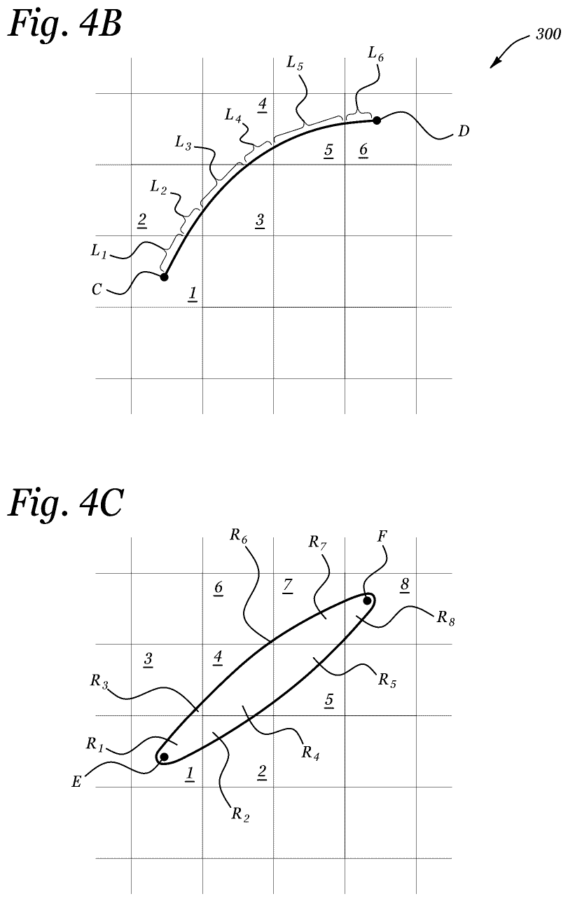

With reference to FIGS. 4A to 4D, various representations of a wave path between a (virtual) source and a receiver are depicted. The wave path is the path taken by a surface wave travelling from the source to the receiver. As described below with reference to FIGS. 4A and 4B, a wave path may be represented by a straight or curved ray connecting the source and receiver. Alternatively, as described below with reference to FIG. 4C, the wave path may be represented by an elliptical Fresnel zone, also known as a Fresnel kernel, between the source and receiver pair. As another alternative, and as described below with reference to FIG. 4D, the wave path may be represented by a curved (“banana”) Fresnel zone.

With reference to FIG. 4A, a ray path is defined as a straight line between two geophones at surface locations A and B on the model 300. A straight ray path model assumes a laterally constant velocity (in other words, the velocity only changes with depth). The straight ray path model provides a sufficiently accurate approximation for the actual path traversed by a wave between a source and receiver in many situations. The straight ray path approximation is also mathematically and computationally efficient compared to other more complex techniques. The ray path signifies the motion of a surface wave as it travels from A to B (or B to A) according to ray theory. In particular, a ray path is defined as the direction of propagation of a surface wave, i.e. the direction perpendicular to wave fronts in wave theory or perpendicular to travel-time contours. The ray path shown in FIG. 4A traverses seven cells of the model 300, numbered 1 to 7. The ray path comprises seven ray segments, each having a length Lᵢ according to the length for which the ray path travels through each cell, i.e. L₁ to L₇ in FIG. 4A.

With reference to FIG. 4B, a ray path is defined as a curved line between two geophones at surface locations C and D. The ray path shown in FIG. 4B traverses six cells of the model 300, numbered 1 to 6. The ray path comprises six ray segments, each having a length Lᵢ according to the length for which the ray path travels through each cell, i.e. L₁ to L₆ in FIG. 4B. The trajectory of the ray path may be calculated using the principle of least time (Fermat's principle) between locations C and D based on the shear wave velocity values of the cells in model 300.

With reference to FIG. 4C, a wave path is represented by an elliptical Fresnel zone between two geophones at surface locations E and F. The Fresnel zone is the region around a geometrical ray (such as the straight ray depicted in FIG. 4A) that follows the direction of the gradient (spatial derivative of travel time) from the receiver (F) to the source (E).

In more detail, and as would be appreciated by the skilled person any wave propagating along a path between a (virtual) source at E and a receiver at F will have some component of the wave that propagates off-axis (not along the straight line connected E to F). This component of the wave that propagates off-axis may be deflected by the wave propagation medium, and some of the deflected wave is then directed towards the receiver at F. The travel time of a wave travelling along a direct (straight) path will therefore differ from a wave travelling along a deflected path, meaning that the direct-path wave and deflected-path wave will arrive at the receiver out of phase. The phase difference may lead to destructive interference when the phase difference is half of a wave period (or one and a half wave periods, or two and a half, or any half of an odd-integer amount). Conversely, the phase difference will lead to constructive interference when the phase difference is between zero and one half of a wave period (or between one and one half, or between any integer n−1 and n−½ wave periods). In other words, the n-th Fresnel zone is defined as the region in which a wave that is deflected at one point will arrive between n−1 and n−½ wavelengths out of phase with a wave travelling along a straight line between a source and receiver pair. In examples of the present disclosure, only the first order Fresnel zone may be considered for the wave path between the source and the receiver, since components of the wave in higher order Fresnel zones become vanishingly small. The general physical principles of Fresnel zones for any wave propagating through any medium are described by B. D Guenther (2005) “Encyclopaedia of Modern Optics”, in which the description of Fresnel zones would be understood by the skilled person to apply to any propagation medium. Fresnel zones for waves travelling through a subsurface target volume are also described by Shibo Xu and Alexey Stovas (2018) “Fresnel zone in VTI and orthorhombic media”.

As illustrated in FIG. 4C, which represents a first order Fresnel zone for a straight-ray approximation, the Fresnel zone is an elliptical shape, with the (virtual) source location E and receiver F being the focal points of the ellipse. In other examples, such as that depicted in FIG. 4D, the Fresnel zone may be a curved, so-called banana shaped region that follows the path of a curved ray between a virtual source G and receiver H. Determining such a curved Fresnel zone follows the same considerations as described above with reference to the elliptical Fresnel zone of FIG. 4A, except that the differential travel time and phase difference is determined with respect to a curved ray (c.f. FIG. 4B) instead of a straight-line ray between the source and receiver.

The Fresnel zone depicted in FIG. 4C covers eight cells of the model 300, numbered 1 to 8. The Fresnel zone comprises eight sub-regions labelled R₁ to R₈, each region being the region of the Fresnel zone in the respective cell 1 to 8. Each sub-region R₁ to R₈ of the Fresnel has a respective sensitivity value that is calculated uniquely for the Fresnel zone. As would be understood by the skilled person, the sensitivity value is a sensitivity to the change in local shear wave velocity (or any other physical property that is being modelled. Such techniques for calculating the sensitivity value for each sub-region of the Fresnel zone (i.e. the sensitivity value for the Fresnel zone for each cell that the Fresnel zone covers) are well known to the skilled person.

The same illustration of sub-regions is also shown for the curved Fresnel zone depicted in FIG. 4D, which passes through cells 1 to 8 and consists of sub-regions R₁ to R₈ (different from the sub-regions depicted in FIG. 4C). Each of the sub-regions depicted in FIG. 4D has a respective sensitivity value, which the skilled person would understand may be different from the sensitivity values for each sub-region depicted in FIG. 4C.

For each of a plurality of virtual source-receiver pairs, such as those depicted in FIG. 2, a respective Fresnel zone may be determined. Each Fresnel zone consists of a respective plurality of sub-regions for each cell that is covered by the Fresnel zone, and each of those sub-regions for each zone has a respective sensitivity value.

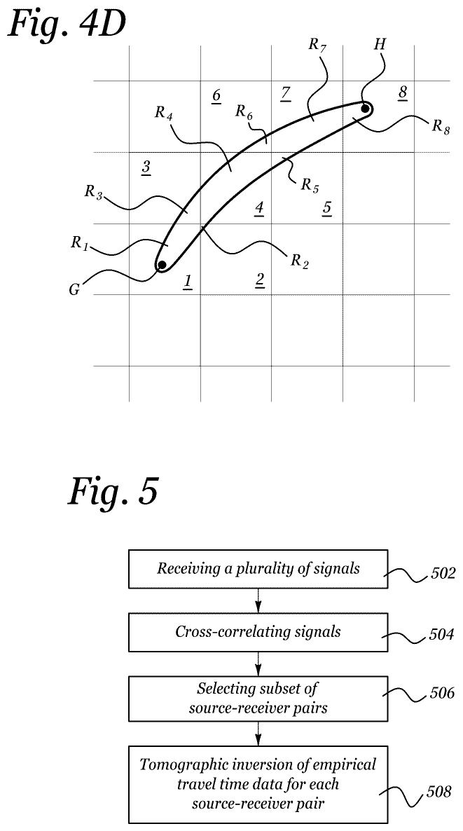

With reference to FIG. 5, a method 500 for determining one or more physical properties of a subsurface target volume includes receiving 502 a plurality of signals detected by geophones arranged on the surface, e.g. as described with reference to FIG. 1. In general, one signal is received from each geophone, although signals from only a subset of the total number of geophones may be received in some circumstances. The signals show the vertical oscillations of the ground measured at the respective geophone as caused by surface waves from ambient noise or an active source, as described above with reference to FIG. 1. The signals may include metadata about the location and time of recording.

The signals may be received directly from the geophones or via one or more intermediary devices. For example, a computing device (as described below with reference to FIG. 10), may be situated locally to the array of geophones for the signals to be transmitted via any form of wired or wireless communication. Alternatively, the signals may be received at a location far from the location of the array of geophones for performing the method 500 remotely from the array of geophones, e.g. by internet communication or transporting a physical computer-readable medium with a recording of the signals saved thereon. In some examples, additional processing steps may be performed on the signals before or after the receiving 502 of the signals to optimise the signals for further processing.

Example geophones can include velocimeters or accelerometers. An example of a particular mechanism for such geophones includes a ferromagnetic mass on a spring moving within an electric coil in response to movement of the surface, thereby inducing an electric current proportional to ground velocity which can be measured.

The method 500 also comprises a step 504 cross-correlating the signals between the plurality of geophones to obtain empirical travel time data for surface waves between a plurality of virtual source-receiver pairs. As described above, this step involves cross-correlating the passive noise signals measured at a pair of receivers to obtain a correlated Green's function, which represents the wavefield as if one of the pair were a virtual source and the other of the pair were a receiver. As would be well understood by the skilled person, information indicative of phase velocity as a function of frequency and information indicative of group velocity as a function of frequency can be derived from the cross-correlation process. In step 504, the cross-correlation of the signals between the plurality of geophones is carried out to obtain group and/or traveltime data for a plurality of frequencies. The frequencies may be continuous so as to obtain group velocity and/or phase velocity dispersion information, or the traveltime data may be obtained for a plurality of finite frequencies. Group traveltime refers to the time taken for a group wave to travel from the virtual source to the receiver. Phase traveltime refers to the time taken for a specific phase component of a wave to travel from the virtual source to the receiver. Since the distance between the virtual source and receiver is known, the group and/or phase velocity or slowness for a plurality of frequencies (which is the inverse of velocity) can be derived from the correlated Green's function for a source-receiver pair. Slowness and traveltime are effectively equivalent, with a scaling factor provided by the distance between source and receiver.

Based on at least the group and/or phase traveltime data for the plurality of frequencies, a model of the physical property of the subsurface target volume can be determined. As described above with reference to FIG. 3, the model comprises a plurality of cells arranged in a two-dimensional grid. Each cell of the model has a respective physical property value (such as a shear wave velocity), which may be include depth profile. In other words, each cell of the model may comprise a one-dimensional model of shear wave velocity as a function of depth, or frequency (which is indicative of depth). Collectively, the cells of the model therefore provide a three-dimensional model of the physical property, since each cell provides a one-dimensional model as a function of depth.

Determining the model of the physical property of the subsurface target volume comprises selecting 506 a subset of the plurality of source-receiver pairs for which empirical traveltime information has been obtained. As described above with reference to FIGS. 4A-4D, a wave path between each source-receiver pair traverses two or more cells of the model. In principle, any and all source-receiver pairs may be suitable for determining the model. However, increasing the number of wave paths used will increase the computational power needed or else cause very long computation times. Therefore, in practice, it is usually beneficial to select a subset of source-receiver pairs, with the number to be selected depending on the computational power available or other practical concerns. Several principles can be used to limit the number of selected pairs. As a preliminary point, due to the reciprocity of cross-correlation, the wave path from a location A to location B is the same as location B to location A and therefore only the choice of paired geophones is needed without regard to which is treated as the virtual source. A first way to deselect pairs is to omit those which do not have suitable traveltime data, i.e. the cross-correlation of the signals from that pair of geophones does not show an identifiable wave passing through both geophones which can be used to find the travel time therebetween. Another way to select wave paths is to omit pairs with low-quality picks, e.g. having a low signal-to-noise ratio, having large uncertainty, being an outlier compared to adjacent picks etc. Any picks that would give non-physical or non-geological results are also excluded, as well as any picks that would be implausible for the specific subsurface target volume under investigation. Lastly, if the remaining number of pairs is still more than can feasibly be used, a subsample of source-receiver pairs may be chosen, e.g. every n^{th} pair or a random selection, etc. In such a situation, other subsamples of suitable source-receiver pairs may be used in succession to increase the total number of pairs used with exceeding memory limitations or available computational power. Regardless of what approaches are used to limit the number of source-receiver pairs (if necessary), the end result is a selection of source-receiver pairs and corresponding wave paths for which empirical group and/or phase traveltime information, such as velocities for a plurality of different frequencies or dispersion functions (e.g. a group velocity dispersion function and/or a phase velocity dispersion function) has been obtained.

As described above with reference to FIGS. 4A-4B, a wave path between a (virtual) source and receiver pair may be a ray path that extends in a straight line between the source and receiver. In some examples, at least some of the ray paths extend in a curved line between the respective source and receiver, as described above with reference to FIG. 4B. At least some of the selected wave paths will traverse at least two cells of the first model, having a ray segment length in each cell which it traverses (including the cells which the ray path starts and ends in). Curved ray paths may be determined according to initial physical property values for the cells of the model. By using curved ray paths determined according to the physical property values of the cells of the model, the ray paths more closely follow the actual ray path that a wave would travel in between the source and the receiver. Therefore, this approach improves the accuracy of the results of the later method processes because it corresponds more closely to the physical reality of surface waves passing through the subsurface target volume.

As described above with reference to FIGS. 4A-4B, in other examples the wave path is represented by a Fresnel zone which provides a region of many possible paths taken by the wave as it travels from the source to the receiver. The Fresnel zone provides a region that covers two or more cells through which a possible wave traverses, with each cell having a respective region of the Fresnel zone with an associated sensitivity value defined by the Fresnel zone. The Fresnel zone may be determined based on initial physical property values for the cells of the mode. Since the Fresnel zone defines a region of possible paths taken by a surface wave travelling from the source to the receiver, this approach improves the accuracy of the resulting model for each cell because it corresponds more closely to the physical reality of surface waves passing through the subsurface target volume and scattering within the volume.

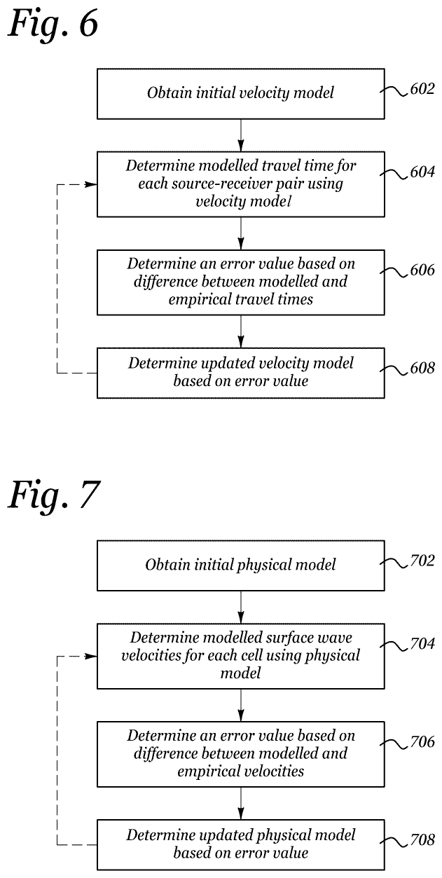

Determining the model of the physical property of the subsurface target volume further comprises performing 508 tomographic inversion on the traveltime data for each of the selected source-receiver pairs. Generally speaking, the tomographic inversion is used to derive a value of the physical property for each cell of the model, from group or phase traveltime data obtained for each of a plurality of source-receiver pairs. As described above, the physical property value for each cell may be a single value, or provided as the physical property as a function of depth. Details of various processes for carrying out the tomographic inversion are described below with reference to FIGS. 6-8. As described throughout this text, the tomographic inversion can be carried out based on empirical group traveltime information or empirical phase dispersion information. In the context of phase dispersion, phase velocity or slowness information may be converted to equivalent traveltime information so that the tomography can be performed on such phase traveltime information.

In some examples, the tomographic inversion step 508 involves process 600 depicted in FIG. 6. FIG. 6 illustrates a method for carrying out traveltime tomography on the traveltime information obtained in step 504 for each source-receiver pair selected in step 506. As described in more detail below, this process tomographically maps the traveltime information from each source-receiver pair into the cells of the physical property model. The result of the process is therefore an empirical model of group and/or phase velocity (depending on the traveltime data used), with each cell of the model having a respective group or phase velocity value. This process 600 is carried out for each of a plurality of frequencies to obtain group or phase velocity values for each cell for each frequency. Process 600 is the first stage (i.e. the tomography stage) of a two-stage tomographic inversion.

Process 600 comprises a step 600 of obtaining an initial velocity model. The initial velocity model comprises initial values of group velocity and/or phase velocity for each cell for each of a plurality of frequencies. The initial velocity model sets initial (group or phase) velocity values for each cell (for each given frequency), which the process 600 will refine using the empirical traveltime data in an iterative process. Accordingly, it is not essential for the initial velocity model and respective initial velocity values to be a highly accurate or high-resolution, although a more accurate initial model may render the tomographic process 600 faster or more accurate at mapping travel times to each cell. A more accurate initial model may also reduce the risk of finding a local-minimum rather than a global minimum in the iterative gradient-descent method, although such an issue can be solved using Monte-Carlo methods. In some examples, the initial velocity model is determined based on a user input, e.g. according to historic data or map information indicating possible physical property values across the subsurface target volume. Alternatively, an arbitrarily chosen typical value of the group/phase velocity can be used for each cell as a starting point. In these examples, the arbitrary model may be selected based on an estimation of the physical properties of the subsurface target volume.

The tomographic process 600 further comprises the step 604 of determining modelled group or phase travel times for each of the selected source-receiver pairs using the initial group or phase velocity model. This is carried out by identifying the wave path from the source to the receiver (for example as a straight ray, curved ray or elliptical/curved Fresnel zone) and identifying the cells that are traversed by the wave path. The modelled traveltime based on the initial velocity model is then determined based on the known distance between the source and receiver and the velocity values of each cell traversed by the wave path.

The tomographic process 600 further comprises the step 606 of determining an error value indicative of the difference between the modelled travel times (determined at step 604) and the empirical travel times (obtained at step 504) for each of the selected source-receiver pairs. For example, the error value could be a simple difference between the modelled and empirical travel times, also called a residual, at each frequency for each source-receiver pair. In some examples, the error value could be a combination of all the differences between modelled and empirical travel times for every source-receiver pair. In general determining the error value is part of an iterative process, for example, in a least-squares inversion method where the squares of the residuals are calculated in order to be minimised through iterations. Other forms of inversion processes use different error values in order to provide feedback to the initial group velocity model.

The process 600 further comprises the step 608 of determining an updated velocity model using the error value. The updated model is generally in all aspects the same as the initial velocity model except for new velocity values associated with at least some of the cells. In other words, the updated model is an updated version of the initial velocity model taking into account the determined error value between the empirical and modelled group or phase travel times for each source-receiver pair. This feedback process may involve a least-squares method, Markov-chain Monte Carlo method or other inversion technique to iteratively update the initial model based on an updated model. Process 600 may be repeated for each of a plurality of finite frequencies.

Steps 604 to 608 are typically all part of a subroutine of the first-stage tomographic process 600, which is then iterated according to the inversion method such as least-squares inversion. The iterative nature of the process 600 is illustrated by the dashed arrow in FIG. 6, which indicates that the updated model determined at step 608 is used to determine new modelled travel times for each source-receiver pair at step 604. In other words, each time an updated model is determined using the error value resulting from the initial model and resulting modelled travel times for each source-receiver pair, the resulting updated model is then used as the initial model for the next iteration. The iteration continues until the error value reaches an end condition, for example, the error value falling below a threshold absolute value of the difference between the modelled and empirical travel times, or falling below a threshold of proportional difference between the modelled and empirical travel times. Another end condition, which could be used alone or in combination with the threshold error value end condition, is that the changes to the initial model to produce the updated model for an iteration falls below a threshold amount or proportion. This is so that if the iteration reaches a settled minimum error value, the iteration can end as further iterations will not make significant accuracy improvements.

Once the tomography of the first-stage process 600 has been carried out to obtain a velocity model comprising a group or phase velocity value for each cell (for each frequency), the tomographic inversion of step 508 can proceed to the second-stage (the inversion) of the two-stage tomographic inversion to obtain the resultant model of the physical property of the target subsurface volume. The second-stage inversion process 700 is depicted in FIG. 7. As with the first-stage tomographic process 600, the second stage inversion process 700 is carried out for each of a plurality of frequencies to obtain group or phase velocity values for each cell for each frequency.

The inversion process 700 comprises a first step 702 of obtaining an initial physical model. The initial physical model is an initial model of the physical property of the subsurface volume, wherein the initial model comprises initial physical property values for each of the cells of the first plurality of cells. The initial physical model may be a shear wave velocity model 300 as described above with reference to FIG. 3, and/or be an initial physical model having any of the features or variations described above with reference to FIG. 3. The initial model sets initial physical property values for each cell of the model, which the method 700 will refine using the group/phase velocity model obtained from iterative tomographic process 600 using a further iterative process. Accordingly, it is not essential for the initial physical model and initial physical property values to be a highly accurate or high-resolution model of the subsurface target volume, although a more accurate first model may increase the expected accuracy of the end result of the method or decrease the computational time to reach the end result.

In some examples, the initial physical model is determined based on a user input, e.g. according to historic data or map information indicating possible physical property values across the subsurface target volume. Alternatively, the initial physical model may be determined using the received signals, e.g. by performing an inversion of group velocity or phase velocity dispersion curves between geophones, which can be calculated from cross-correlation of the signals as described above, to find a using a coarser grid or quicker method. As a last resort, an arbitrarily chosen typical value of the physical property can be used for each cell as a starting point, which may be based on estimated physical properties of the subsurface target volume, In some examples, the initial physical model may be determined based on empirical phase dispersion data between source-receiver pairs. Phase velocity information is acquired as a point in 2D phase space (a dispersion spectrum) which may be obtained by a 2D transform of an array of waveforms (time-distance space), the transform may be Radon, slant-slack, FK or any other suitable methods apparent to the skilled person. The generation of dispersion curves showing the phase velocity as a function of frequency may provide a preliminary three-dimensional model of the shear velocities in a 3D model. However, since the acquisition of the phase velocity is essentially an average frequency-dependent velocity between measurement nodes, the resolution of this model is relatively low. Thus, a physical model derived solely from empirical phase dispersion data may be used as an initial model for an inversion which also takes into account empirical group dispersion data to obtain a more accurate final 3D model of the subsurface target volume.

Process 700 further comprises a step 704 of determining modelled surface wave velocities for each cell based on the initial model. In more detail, a forward modelling approach is used to derive the phase and/or group velocities for each cell of the initial physical model, using the respective physical property value for the given cell. For example, the physical property values of each cell may be a shear wave velocity. The values of shear wave velocity of for each cell can be used to calculate a corresponding phase velocity dispersion function (and thus a phase velocity for a given frequency) using the propagation matrix method introduced by Thomson ((1950). “Transmission of elastic waves through a stratified solid medium”, Journal of applied Physics, 21(2), 89-93) and Haskell ((1953) “The dispersion of surface waves on multilayered media”. Bulletin of the seismological Society of America, 43(1), 17-34). The skilled person would be well aware of this and other approaches that can be used to forward model group or phase velocities (or dispersion functions) from shear wave velocity values (or functions of depth).

The inversion process further comprises the step 706 of determining an error value indicative of the difference between the modelled velocities (determined at step 704 based on the initial physical model) and the empirical velocities (obtained from process 600) for each cell of the model. The error value may be determined for each cell in a similar manner to that described above in relation to step 606 in which an error value is determined between modelled and empirical travel times for each source-receiver pair. As with the tomographic process 600, in general determining the error value at step 706 is part of an iterative process, for example, in a least-squares inversion method where the squares of the residuals are calculated in order to be minimised through iterations. Other forms of inversion processes use different error values in order to provide feedback to the initial model of the physical properties of the subsurface target volume.

The process 700 further comprises the step 708 of determining an updated physical model based on the error value determined at step 706. The updated physical model is generally in all aspects the same as the initial physical model except for new physical property values associated with at least some of the cells. In other words, the updated model is an updated version of the initial physical model taking into account the determined error value between the empirical and modelled surface wave velocities for each cell of the model. This feedback process may involve a least-squares method, Markov-chain Monte Carlo method or other inversion technique to iteratively update the initial physical model based on an updated physical model.

Steps 704 to 708 are typically all part of a subroutine of the second-stage inversion process 700, which is then iterated according to the inversion method such as least-squares inversion. The iterative nature of the process 700 is illustrated by the dashed arrow in FIG. 7, which indicates that the updated model determined at step 708 is used to determine new surface wave velocities for each cell at 704. In other words, each time an updated model is determined using the error value resulting from the initial model and resulting modelled velocities for each cell, the resulting updated model is then used as the initial model for the next iteration. The iteration continues until the error value reaches an end condition, such as an end criterion described above in relation to FIG. 6.

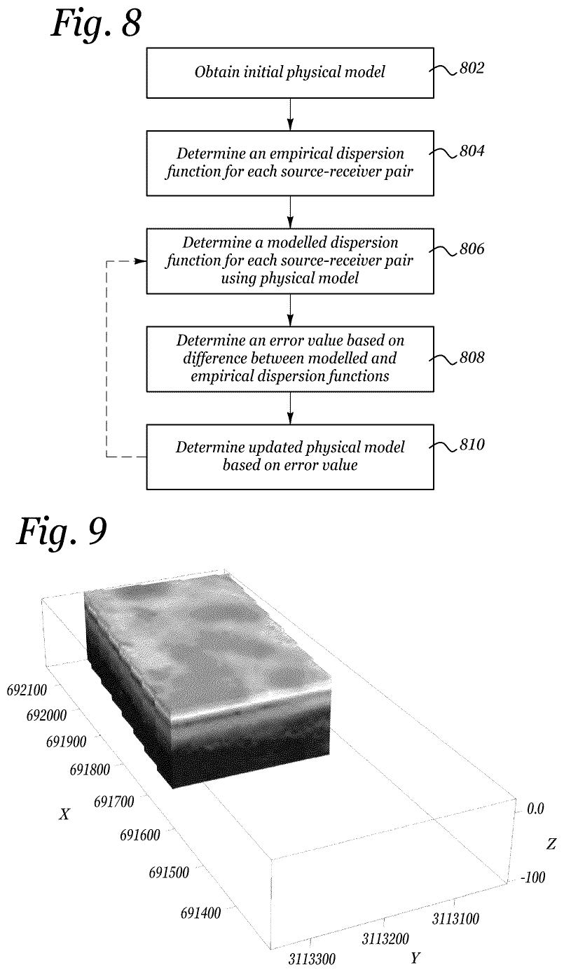

An alternative tomographic inversion process 800 is now described with reference to FIG. 8. This tomographic inversion process is a single-stage process in which the tomography and inversion are combined. This means that the iterative inversion stage to find the physical property values for the model is carried out for each wave path between a respective source-receiver pair, rather than for each cell of the model. This means that the initial tomography stage (process 600) for mapping surface wave velocities between source-receiver pairs to cells is not required in the single-stage process 800 because the physical property model inversion process carries out the inversion on each wave path, rather than each cell. In other words, the two-stage tomographic inversion first uses traveltime tomography to map traveltime information along wave paths into surface wave velocity information for a grid of cells. The two-stage tomographic inversion then carries out a cell-by-cell inversion of the surface wave velocity information (surface wave velocity as a function of frequency) to obtain a corresponding shear wave velocity function (as a function of depth) for each cell. In contrast, as described below, the one-stage process carries out a direct inversion of the surface wave velocity information for each wave path (for each source-receiver pair) to obtain a shear wave velocity function for the wave path, which is tomographically mapped to each cell of the model.

Process 800 begins with obtaining an initial physical model in the same manner as described in relation to step 702 for FIG. 7. The initial model sets initial physical property values for each cell of the model, which the method 800 will refine using the empirical traveltime data for each source-receiver pair. In some examples, the initial physical model may be determined based on empirical phase dispersion data between source-receiver pairs.

The method 800 further comprises determining 804 an empirical dispersion function for each wave path (i.e. each source-receiver pair), in particular, each wave path selected in the selecting 506 part of the method. The dispersion function may be a group velocity dispersion function or a phase velocity dispersion function (or both may be used). The dispersion function may be determined as described above with reference to FIG. 1, according to any of the usual methods in the art.

The method 800 further comprises determining 806 a modelled dispersion function for each wave path using the first model. For example, the values of shear wave velocity of the first model can be used to calculate a phase velocity dispersion function using the propagation matrix method introduced by Thomson ((1950). “Transmission of elastic waves through a stratified solid medium”, Journal of applied Physics, 21(2), 89-93) and Haskell ((1953) “The dispersion of surface waves on multilayered media”. Bulletin of the seismological Society of America, 43(1), 17-34), using a model of a stack of homogenous layers with finite thickness (overlying a homogenous half-space).

In particular, this can be performed using any available solver using a modal approximation method, such as written by Herrmann ((2013) “Computer programs in seismology: An evolving tool for instruction and research” Seismological Research Letters, 84(6), 1081-1088). This approach computes the phase velocity Vphase for a particular frequency ω from a stack of homogeneous layers with finite thickness, i.e. a 1-dimensional velocity profile. The first step consists of establishing the boundaries of where the phase velocity will lie between, e.g. the minimum and maximum Vs present in the model. For an arbitrary value of w, a trial value of wavenumber k is then tested and iteratively changed with a set increment until the eigenvalue solution is found. This eigenvalue can subsequently be used to calculate the solution to the eigenfunction, which will be tested against an iteratively changing value of Vphase to find the root of the solution and therefore a phase velocity dispersion function.

Herrmann's modal approximation code takes as inputs a list of layered elastic parameters and the frequency values of interest and outputs a dispersion function as the solution of the eigenvalue problem defined by the matrix propagator method introduced by Haskell and Thomson. Herrmann's solver is widely used and available as a software package from Saint Louis University Earthquake Center, “Computer Programs in Seismology” page https://www.eas.slu.edu/eqc/eqccps.html, along with extensive manuals and instructions for using this software (in addition to the 2013 paper “Computer programs in seismology: An evolving tool for instruction and research” references above). Alternative solvers are also available via GitHub, such as https://github.com/xin2zhang/MCTomo based on 3D Monte Carlo tomography (Zhang, X., Curtis, A., Galetti, E., & de Ridder, S., 2018. “3-D Monte Carlo surface wave tomography”, Geophysical Journal International, 215(3), 1644-1658), or https://github.com/keurfonluu/disba by Keurfon Luu (also available at zenodo.org titled keurfonluu/disba: disba v0.5.1 and which, according to its documentation page, implements “a subset of codes from Computer Programs in Seismology (CPS) in Python compiled just-in-time with numba”.

In additional to or alternatively to shear wave velocity, other physical properties may be used which are related to shear wave velocity. For example, the longitudinal wave (P-wave) velocity Vp and shear wave (or transverse/S-wave) velocity Vs are related to other physical properties of the ground elastic modulus λ, shear modulus μ, and density ρ by the following equations from linear elasticity theory:

$${V}_{p} = \sqrt{\frac{λ + 2 μ}{ρ}} \qquad Equation 1 ( longitudinal wave velocity )$$

$${V}_{s} = \sqrt{\frac{μ}{ρ}} \qquad Equation 2 ( shear wave velocity )$$

In summary, there are established methods for determining a phase velocity dispersion function from a stack of homogenous layers (constant is x and y directions) with finite thickness and associated shear wave velocity values (or related physical properties) for each layer. Accordingly, one way to use the methods developed by Thomson and Haskell and Herrmann is to use multiple wave paths between geophones that intersect within a particular cell of the model and combine the dispersion functions of the wave paths to determine a dispersion relation for that particular cell. The dispersion relation for that cell can then be used for ‘inversion’ using the homogenous layers approach using the shear wave velocity values for that cell, i.e. refining the model values in that cell to better produce the dispersion relation found for that cell (and doing likewise for all cells individually). However, the inventors have developed a different approach wherein, instead of performing the inversion on each cell, the inversion is done for a whole wave path using the multiple shear wave velocity values in the cells that the wave path traverses. This approach has numerous advantages, including improved computational efficiency, allowing for geophone arrays with more geophones and/or higher resolution models, and increased accuracy of the model determination. For example, because the shear wave velocity model is refined in a single step from the dispersion functions found between geophones, this removes the extra step of the travel-time tomography using the wave paths for each cell, which is an extra source of approximation and therefore inaccuracies because the inversion is independent for each cell (therefore losing the interdependence of crossing wave paths in the inversion step). In addition to removing an extra step in the process, thereby reducing the amount of computational power needed, performing the inversion in a single step also means that a least-squares method can be used rather than more computationally intensive Monte-Carlo inversion methods. This in turn means that the inversion compute time is reduced or, for the same amount of compute time, more geophone signals can be processed or a higher resolution model can be produced.

In some examples, the determining 806 the modelled dispersion function for each wave path is performed by averaging the shear wave velocity values of the cells which that wave path traverses. In particular, for shear wave velocity, the 1/Vs values are averaged because the travel-time through each cell is inversely proportional to velocity. For other physical properties of the cells, such as density, a simple arithmetic mean of the values in each cell may be suitable. In either case, the values are still a function of depth. The averaged shear wave velocity (or other averaged physical property) is then used in the Herrmann modal approximation method to determine the modelled dispersion function for the whole wave path. This averaging process can be implemented in the solver software as an additional function prior to running the inversion routine.

In some examples, the averaging of the shear wave velocity values is a weighted average, weighted according to the ray segment length in each cell, as set out in equation 3, which applies to straight wave paths or curved wave paths. For wave paths represented by Fresnel zones, the weights will also include an additional term corresponding to the sensitivity of the wave path to variations in the local velocity at different parts of the Fresnel zone (i.e. there is higher sensitivity at the centre of the zone that the peripheries). Using a weighted average increases the accuracy of the calculation as it more closely corresponds to the actual values that the wave path will experience between the pair of geophones.

$$\frac{1}{{Vs}_{A \to B}} = \frac{1}{{L}_{A \to B}} {\sum }_{i = 1}^{N} {L}_{i} \frac{1}{{Vs}_{i}} \qquad Equation 3$$

where:
VS_{A->B} is the average shear wave velocity for the wave path A to B (as a function of depth);
N is the number of cells of the first model that the wave path A to B traverses;
Lᵢ is the ray segment length of the i^{th} cell along the wave path;
L_{A->B} is the total wave path length from A to B, i.e. the sum of all Lᵢ;
Vsᵢ is the shear wave velocity value for the i^{th} cell along the wave path (as a function of depth).

In some examples, rather than first averaging the shear wave velocity values along the wave path length, the modal approximation method is performed to produce a dispersion function for each cell and then the cell dispersion functions for each cell which the wave path traverses are averaged to produce the modelled dispersion function for the wave path. This can be done by averaging 1/V phase for phase velocity dispersion function (or conversely 1/V group for group velocity dispersion function) for each cell along the wave path, optionally including weightings analogously to the averaging described above. This averaging process can be implemented in the solver software as an additional function after running the inversion routine

The method further comprises determining 808 an error value indicative of the difference between the modelled dispersion function (determined 806 from the model) and the empirical dispersion function (determined 804 from the detected signals) for each wave path (i.e. each source-receiver pair). The error value may be determined for each wave path a similar manner to that described above in relation to steps 606 and 706. As with the two-stage tomographic processes 600 and 700, in general determining the error value at step 808 is part of an iterative process, for example, in a least-squares inversion method where the squares of the residuals are calculated in order to be minimised through iterations. Other forms of inversion processes use different error values in order to provide feedback to the initial model of the physical properties of the subsurface target volume.

The process 800 further comprises the step 810 of determining an updated physical model based on the error value determined at step 808. The updated physical model is generally in all aspects the same as the initial physical model except for new physical property values associated with at least some of the cells. In other words, the updated model is an updated version of the initial physical model taking into account the determined error value between the empirical and modelled surface wave velocities for each cell of the model. This feedback process may involve a least-squares method, Markov-chain Monte Carlo method or other inversion technique to iteratively update the initial physical model based on an updated physical model.

In some examples, the determined error value indicates that the empirical dispersion function along a wave path shows larger values for phase velocity (or group velocity) than the modelled dispersion function, either across the function or in one or more frequency bands. Accordingly, this indicates that the values of shear wave velocity values along that wave path are less than the true physical properties of the subsurface target volume. As such, determining the second model using the error value comprises recording new shear wave velocity values for the cells which that wave path traverses which are greater than the corresponding values in the first model. Conversely, if the empirical dispersion function has smaller values than the modelled dispersion function, then the values of the shear wave velocity values along that wave path are greater than the true values in the subsurface volume and the model should be updated accordingly.

One way to update the first model to determine the second model is to find an empirical shear wave velocity average for the wave path through inversion of the dispersion function, and to scale each of the shear wave velocity values from the first model according to a difference between the empirical shear wave velocity average and the average shear wave velocity of the first model for that wave path. In more detail, the update factor for the first model for each wave path maybe defined as the ratio of: the difference between the empirical shear wave velocity average and the average shear wave velocity of the first model for that wave path; and the average shear wave velocity of the first model for that wave path. In practice, this entails doing an arithmetic mean of 1/Vs, also referred to as the ‘slowness’, because cells with smaller shear wave velocity will have a bigger impact on the average shear wave velocity over the whole wave path. Optionally, the updating of the first model to produce the second model includes weighting the change to the shear wave velocity values for each cell according to the ray segment length of the wave path in that cell, according to the approach explained above with reference to determining 510 the modelled dispersion function part of the method 500.

In some examples, the shear wave values of the first model are updated to produce the second model using a sensitivity matrix method. In this approach, partial derivatives of the error value (or residual) are determined with respect to the shear wave velocity and/or other parameters of the first model, such as depth of boundaries between shear wave velocity values in a given cell, longitudinal wave velocity, density, etc. The partial derivatives are assembled into a sensitivity matrix and a linear system of equations is solved to determine how to change the parameters of the first model such that the overall error value is reduced for the second model with updated values.

Once the updates to the values of the first cell along a first wave path (e.g. a ray or a Fresnel zone) are calculated, these updates can be applied to produce the second model directly. Alternatively, the updates to values of all cells as influenced by each wave path calculation and inversion can be combined and applied to the values of the first model at once to produce the second model.

Steps 806 to 810 are typically all part of a subroutine of the single-stage tomographic inversion process 800, which is then iterated according to the inversion method such as least-squares inversion. The iterative nature of the process 800 is illustrated by the dashed arrow in FIG. 8, which indicates that the updated model determined at step 810 is used to determine new surface wave velocities for each cell at 806. In other words, each time an updated model is determined using the error value resulting from the initial model and resulting modelled velocities for each cell, the resulting updated model is then used as the initial model for the next iteration. The iteration continues until the error value reaches an end condition, such as an end criterion described above in relation to FIGS. 6 and 7.

With reference to FIG. 8, although the parts of the method 800 have been arranged and numbered in a sequence, the method is not limited to the particular order in which the parts are presented herein. As an example, there is no requirement for either the empirical dispersion function or the first modelled dispersion function to be performed before the other.

In some examples, once a final second model has been determined, e.g. once the iterations satisfy the end condition, the final second model may be sent to an output device. For example, the final second model may be displayed on a monitor or other user interface, or sent via wired or wireless communication to another computing device for further processing or display.

With reference to FIG. 9, an example output of the methods described herein is a final shear wave velocity model showing a subsurface target volume. The subsurface target volume extends in x and y directions to a depth (z direction) of 100 m. The values of shear wave velocity are shown by the shading in the plot and the transition between regions of different shear wave velocity are visible, which indicates the different composition or structure of portions of the subsurface target region. Using the methods described herein, a final shear wave velocity model can be determined with higher resolution and accuracy without resulting in an unfeasible compute time. Such a subsurface model can be used to better understand the suitability of the subsurface target volume for supporting man-made structures on top of or in the subsurface target volume.

Optionally, additional physical properties of the subsurface target volume can be determined from the final shear wave velocity model, e.g. calculated using one or more of equations 1 and 2. These further physical properties can be recorded in the shear wave velocity model itself, or outputted separated to an output device.

FIG. 10 shows a block diagram of one implementation of a computing device 1000 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 1000 includes a processor 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a secondary memory (e.g., a data storage device 1018), which communicate with each other via a bus 1030.

Processor 1002 represents one or more general-purpose processors such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processors such as an application specific integrated circuit (ASIC), a field programmable gate array (FPGA), a digital signal processor (DSP), network processor, or the like. Processor 1002 is configured to execute the processing logic (instructions 1022) for performing the operations and steps discussed herein.

The computing device 1000 may further include a network interface device 1008. The computing device 1000 also may include a video display unit 1010 (e.g., a liquid crystal display (LCD) or a cathode ray tube (CRT)), an alphanumeric input device 1012 (e.g., a keyboard or touchscreen), a cursor control device 1014 (e.g., a mouse or touchscreen), and an audio device 1016 (e.g., a speaker).

It will be apparent that some features of computer device 1000 shown in FIG. 10 may be absent. For example, one or more computing devices 1000 may have no need for display device 1010 (or any associated adapters). This may be the case, for example, for particular server-side computer apparatuses 1000 which are used only for their processing capabilities and do not need to display information to users. Similarly, user input device 1012 may not be required. In its simplest form, computer device 1000 comprises processor 1002 and memory 1004.

The data storage device 1018 may include one or more machine-readable storage media (or more specifically one or more non-transitory computer-readable storage media) 1028 on which is stored one or more sets of instructions 1022 embodying any one or more of the methodologies or functions described herein. The instructions 1022 may also reside, completely or at least partially, within the main memory 1004 and/or within the processor 1002 during execution thereof by the computer system 1000, the main memory 1004 and the processor 1002 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “calculating”, “averaging,” “identifying”, “updating”, “solving”, “outputting” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer implemented method for determining a physical property of a subsurface target volume, the method comprising:
receiving a plurality of signals detected by a plurality of receivers arranged on a surface above the subsurface target volume, wherein each respective signal of the plurality of signals is detected by a respective receiver of the plurality of receivers;
cross-correlating signals between the plurality of receivers to obtain empirical travel time data for surface waves between a plurality of virtual source-receiver pairs; and
determining a model of the physical property of the subsurface target volume, the model comprising a first plurality of cells arranged in a first two-dimensional grid, wherein each cell has a respective physical property value and wherein the two-dimensional grid spans at least an area of the surface, wherein determining the model comprises:
selecting a subset of the plurality of virtual source-receiver pairs, wherein a surface wave path between each virtual source and respective receiver traverses two or more cells of the first plurality of cells;
performing tomographic inversion on the empirical travel time data between each virtual source-receiver pair in the subset to obtain a physical property value for each cell.

2. The computer implemented method of claim 1, wherein performing the tomographic inversion comprises:
obtaining an initial velocity model comprising initial values indicative of velocity for each of the cells of the first plurality of cells,
for each virtual source-receiver pair of the subset, determining a modelled travel time using the initial first velocity model values associated with the two or more cells that are traversed by the surface wave path;
determining a first error value indicative of a difference between the modelled travel times and corresponding empirical travel times for each virtual source-receiver pair in the subset; and
determining an updated velocity model based on the first error value, wherein the updated velocity model comprises updated values indicative of velocity for each of the first plurality of cells.

3. The computer implemented method of claim 2, wherein
determining the modelled travel time, determining the first error value, and determining the updated velocity model based on the first error value are iterated until the first error value meets a first end condition, and wherein the updated velocity model of each iteration is used as the initial velocity model of a next iteration.

4. The computer implemented method of claim 2, wherein determining the modelled travel time, determining the first error value, and determining the updated velocity model based on the first error value are performed using iterative non-linear least-squares inversion.

5. The computer implemented method of claim 2, wherein performing the tomographic inversion further comprises:
for each cell of the first plurality of cells, performing an inversion of the updated values indicative of velocity to obtain a physical property value for the cell.

6. The computer implemented method of claim 5, wherein performing the inversion comprises:
obtaining an initial model of the physical property of the subsurface target volume, wherein the initial model comprises initial physical property values for each of the cells of the first plurality of cells;
for each cell of the first plurality of cells, determining modelled values indicative of velocity based on the initial physical property value for the cell;
determining a second error value indicative of a difference between the modelled values indicative of velocity and the corresponding values indicative of velocity obtained from the updated velocity model; and
determining an updated model of the physical property of the subsurface target volume based on the second error value, wherein the updated model of the physical property of the subsurface target volume comprises updated physical property values for each of the first plurality of cells.

7. The computer implemented method of claim 6, wherein determining the modelled values indicative of velocity, determining the second error value, and determining the updated model of the physical property of the subsurface target volume based on the second error value are iterated until the second error value meets a second end condition, and wherein the updated model of the physical property of the subsurface target volume of each iteration is used as the initial physical property value of the subsurface target volume of a next iteration.

8. The computer implemented method of claim 6, wherein determining the modelled values indicative of velocity, determining the second error value, and determining the updated model of the physical property of the subsurface target volume based on the second error value are performed using iterative non-linear least-squares inversion.

9. The computer implemented method of claim 1, wherein performing tomographic inversion comprises:
obtaining an initial model of the physical property of the subsurface target volume wherein the initial model comprises initial physical property values for each of the cells of the first plurality of cells;
determining an empirical dispersion function for each virtual source-receiver pair of the subset using the empirical travel time data;
determining a modelled dispersion function for each virtual source-receiver pair of the subset using the initial physical property values associated with the two or more cells that are traversed by a surface wave travelling from the virtual source to the receiver;
determining a third error value indicative of a difference between the modelled dispersion function and the empirical dispersion function for each virtual source-receiver pair; and
determining an updated model of the physical property of the subsurface target volume based on the third error value, wherein the updated model of the physical property of the subsurface target volume comprises updated physical property values for each of the first plurality of cells.

10. The computer implemented method of claim 9, wherein determining the modelled dispersion function for each virtual source-receiver pair comprises:
averaging, the updated physical property values of the two or more cells that are traversed by a surface wave travelling from the virtual source to the receiver; and
calculating the modelled dispersion function using the averaged physical property value;
or:
calculating a cell dispersion function for each of the two or more cells that are traversed by a surface wave travelling from the virtual source to the receiver to provide a plurality of cell dispersion functions, wherein calculating each cell dispersion function comprises using the physical property value of the respective cell; and
averaging the plurality of cell dispersion functions

11. The computer implemented method of claim 1, wherein the surface wave path taken by a surface wave between each virtual source and receiver pair is represented by a straight or curved ray.

12. The computer implemented method of claim 11, wherein the averaging comprises determining a weighted average according to a respective weight for each cell of the two or more cells, wherein the respective weight for each cell corresponds to a segment length of a ray path in that cell.

13. The computer implemented method of claim 1, wherein the surface wave path taken by a surface wave between each virtual source and receiver pair is represented by a Fresnel zone.

14. The computer implemented method of claim 13, wherein the averaging comprises determining a weighted average according to a respective weight for each cell of the two or more cells, wherein the respective weight for each cell corresponds to a sensitivity value of the Fresnel zone in that cell.

15. The computer implemented method of claim 9, wherein determining the updated model of the physical property of the subsurface target volume comprises updating the initial physical property value of each cell according to a respective weighting of the surface wave path taken by a surface wave in that cell.

16.-26. (canceled)

27. A system comprising:
one or more processors;
one or more memories having stored thereon computer readable instructions configured to cause the one or more processors to:
receive a plurality of signals detected by a plurality of receivers arranged on a surface above a subsurface target volume, wherein each respective signal of the plurality of signals is detected by a respective receiver of the plurality of receivers;
cross-correlating signals between the plurality of receivers to obtain empirical travel time data for surface waves between a plurality of virtual source-receiver pairs; and
determine a model of a physical property of the subsurface target volume, the model comprising a first plurality of cells arranged in a two-dimensional grid, wherein each cell has a respective physical property value and wherein the two-dimensional grid spans at least an area of the surface, wherein determining the model comprises:
select a subset of the plurality of virtual source-receiver pairs, wherein a surface wave path between each virtual source and respective receiver traverses two or more cells of the first plurality of cells;
perform tomographic inversion on the empirical travel time data between each virtual source-receiver pair in the subset to obtain a physical property value for each cell.

28. (canceled)

29. The system of claim 27, wherein performing tomographic inversion comprises:
obtaining an initial model of the physical property value of the subsurface target volume wherein the initial model comprises initial physical property values for each of the cells of the first plurality of cells;
determining an empirical dispersion function for each virtual source-receiver pair of the subset using the empirical travel time data;
determining a modelled dispersion function for each virtual source-receiver pair of the subset using the initial physical property values associated with the two or more cells that are traversed by a surface wave travelling from the virtual source to the receiver;
determining a third error value indicative of a difference between the modelled dispersion function and the empirical dispersion function for each virtual source-receiver pair; and
determining an updated model of the physical property of the subsurface target volume based on the third error value, wherein the updated model of the physical property of the subsurface target volume comprises updated physical property values for each of the first plurality of cells.

30. The system according to claim 29, wherein determining the modelled dispersion function based on the initial model, determining the third error value, and determining the updated model of the physical property value of the subsurface target volume are iterated until the third error value meets a third end condition, wherein the updated model of each iteration is used as the initial model of in a next iteration.

31. The system according to claim 29, wherein an end condition includes one or more of:
the third error value of a latest iteration is less than a predetermined threshold error value; and
a difference between the third error value of a latest iteration and the third error value of a preceding iteration is less than a predetermined difference threshold.

32. The system according to claim 29, wherein the determining the modelled dispersion function, the determining the third error value, and the determining the updated model of the physical property values are performed using non-linear iterative least squares inversion.
